(19) United States
(12) Patent Application Publication
(10) Pub. No.: US 2008/0002623 A1
(43) Pub. Date: Jan. 3, 2008

(54) Control method, apparatus, computer program product and computer program distribution medium

(75) Inventors: Antti Piipponen, Tampere (FI); Aarno Parssinen, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/517,475

(22) Filed: Sep. 8, 2006

(30) Foreign Application Priority Data
Jun. 29, 2006 (FI) 20065455

(51) Int. Cl. H04Q 7/00

(52) U.S. Cl. 370/331

(57) ABSTRACT

The invention relates to a control method comprising: checking access status of a plurality of radio protocols; scheduling at least one resource unit for the use of the radio protocols according to the access status; reserving the at least one resource unit for the use of the radio protocols according to the access status and configuring the at least one reserved resource unit according to the scheduling.

### FIELD

The invention relates to a control method, apparatus, computer program product and computer program distribution medium.

### BACKGROUND

New radio technologies are emerging, and user devices in a communications system are capable of using multiple radio systems, such as Global System for Mobile communication (GSM), Universal Mobile Telephone System (UMTS) and Personal Communications Services (PCS).

Additionally, new kind of services and other networks than cellular radio systems have also been developed. Examples of such services are Wireless Local Area Network (WLAN) offering a wireless access to the Internet and Digital Video Broadcasting—Handheld (DVB-H) offering reception of digital television transmissions.

In radio frequency (RF) circuit designs for such multiradio user devices, receiver and transmitter chains are usually re-configurable for use in different communications systems. In other words, there are not necessarily separate transceivers for each supported system. The controlling of the use of shared resources is a problem, especially when different systems are operating simultaneously or when devices are receiving and transmitting at the same time.

Some prior art methods have been developed, but they are tightly woven into the protocol software, such as a simultaneous use of GSM and UMTS systems, or the interoperability issues are planned at higher protocol layers, when the sharing of lower level resources, such as hardware resources, cannot be sufficiently controlled.

### BRIEF DESCRIPTION OF THE INVENTION

According to an aspect of the invention, there is provided a control method comprising: checking access status of a plurality of radio protocols; scheduling at least one resource unit for the use of the radio protocols according to the access status; reserving the at least one resource unit for the use of the radio protocols according to the access status; and configuring the at least one reserved resource unit according to the scheduling.

According to another aspect of the invention, there is provided an apparatus, comprising: means for checking access status of a plurality of radio protocols; means for scheduling at least one resource unit for the use of the radio protocols according to the access status; means for reserving the at least one resource unit for the use of the radio protocols according to the access status; and configuring the at least one reserved resource unit according to the scheduling.

According to another aspect of the invention, there is provided an apparatus, configured to: check access status of a plurality of radio protocols; schedule at least one resource unit for the use of the radio protocols according to the access status; reserve the at least one resource unit for the use of the radio protocols according to the access status; and configure the at least one reserved resource unit according to the scheduling.

According to another aspect of the invention, there is provided a computer program product encoding a computer program of instructions for executing a computer process for configuration controlling, the process comprising: checking access status of a plurality of radio protocols; scheduling at least one resource unit for the use of the radio protocols according to the access status; reserving the at least one resource unit for the use of the radio protocols according to the access status; and configuring the at least one reserved resource unit according to the scheduling.

According to another aspect of the invention, there is provided a computer program distribution medium readable by a computer and encoding a computer program of instructions for executing a computer process for configuration controlling, the process comprising: checking access status of a plurality of radio protocols; scheduling at least one resource unit for the use of the radio protocols according to the access status; reserving the at least one resource unit for the use of the radio protocols according to the access status; and configuring the at least one reserved resource unit according to the scheduling.

The invention provides several advantages.

An embodiment of the invention provides an efficient control for utilizing shared hardware resources in multiradio devices. The embodiment is especially suitable for multiradio devices which are adjustable for variable combinations of radio protocols.

### LIST OF DRAWINGS

In the following, the invention will be described in greater detail with reference to the embodiments and the accompanying drawings, in which

FIG. 1 shows an example of a communications system;

FIG. 2 is a flow chart,

FIG. 3A-C show an example of a multiradio hardware platform; and

FIG. 4 illustrates an example of a communication device.

### DESCRIPTION OF EMBODIMENTS

There are many different radio protocols that are used in communications systems. Some examples of different communication systems are the Universal Mobile Telecommunications System (UMTS) radio access network (UTRAN), Global System for Mobile Communications (GSM) and its modifications, Wireless Local Area Network (WLAN), Worldwide Interoperability for Microwave Access (WiMAX), Bluetooth®, Personal Communications Services (PCS) and systems using ultra-wideband (UWB) technology.

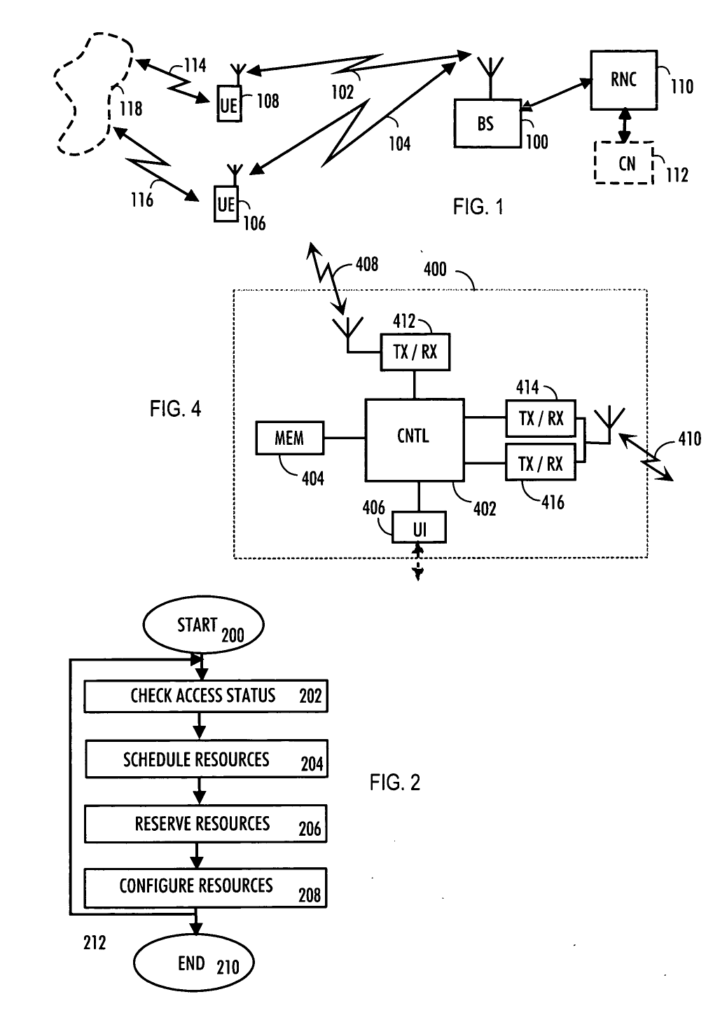

FIG. 1 is a simplified illustration of a communications system to which embodiments according to the invention are applicable. FIG. 1 shows a part of a UMTS radio access network (UTRAN). UTRAN is a radio access network which includes wideband code division multiple access (WCDMA) technology.

The communications system is a cellular radio system which comprises a base station (or node B) 100, which has bi-directional radio links 102 and 104 to user devices 106 and 108. The user devices may be fixed, vehicle-mounted or portable. The user devices are multiradio devices being equipped to operate in a plurality of communication systems and/or providing support for several services. Hence, in this example, the user devices are able to support in addition to UMTS also WLAN or Bluetooth®, for instance. The other systems are marked in FIG. 1 with a cloud 118. The user devices may include a wireless headset, GPS apparatus, etc. for providing connections to other systems and/or additional services. Connections to other communications systems are marked in FIG. 1 with arrows 114, 116.

The base station includes transceivers, for instance. From the transceivers of the base station, a connection is provided to an antenna unit that establishes bi-directional radio links to the user devices. The base station is further connected to a controller 110, a radio network controller (RNC), which transmits the connections of the devices to the other parts of the network. The radio network controller controls in a centralized manner several base stations connected to it. The radio network controller is further connected to a core network 112 (CN). Depending on the system, the counterpart on the CN side can be a mobile services switching centre (MSC), a media gateway (MGW) or a serving GPRS (general packet radio service) support node (SGSN), etc.

It should be noticed that in future radio networks, the functionality of an RNC may be distributed among (possibly a subset of) base stations.

The embodiments are not, however, restricted to the system given as an example but a person skilled in the art may apply the solution to other communication systems provided with the necessary properties. Different multiple radio protocols may be used in the communications systems in which embodiments of the invention are applicable. The radio protocols used are not relevant regarding the embodiments of the invention.

The communication system is also able to communicate with other networks, such as a public switched telephone network or the Internet.

In radio frequency (RF) circuit designs for multiradio devices, receiver and transmitter chains are usually re-configurable for use in different communications systems. This creates a need for controlling of shared resources.

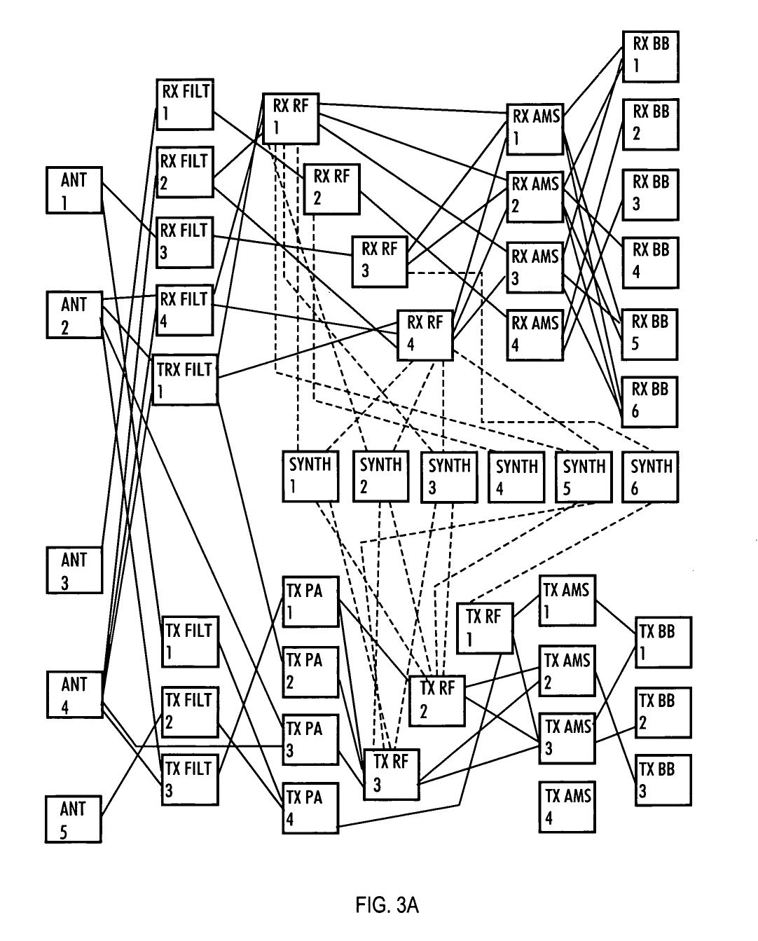

Next an embodiment of a control method according to the invention is explained in further detail by the means of FIG. 2. The embodiment carries out a configuration control of a multiradio device.

If a communication device supports more than one communications system or service protocol, such as DVB-H, the device can be called a multiradio device.

In radio frequency (RF) circuit designs for such multiradio devices, receiver and transmitter chains are usually re-configurable for use in different communications systems. In other words, there are no separate transceivers for each supported system. Shared resources need efficient controlling.

Digital radio systems usually have timing allocation tables for radio protocols. The timing allocation tables are used for timing signal transmission and reception in the communications network. In an embodiment of the invention, the information stored in the prior art timing allocation tables, or other relevant timing information available, is used to create a configuration management function for resource units, such as hardware elements, for granting different radio protocols an access to the resource units and configuring the resource units for active radio protocols. The configuration management functions may also dynamically optimize parallel resource unit chains to different radio protocols based on access grants and protocol prioritization.

An embodiment of the invention also provides information transfer of available resources and their use to higher levels, for instance how many and which radio protocols can be active simultaneously.

The embodiment starts in block 200.

In block 202, access status of a plurality of radio protocols is checked. The access status information includes information on the radio systems or services to which accesses are granted and a moment when they are activated (timing information). It should be noticed that some kind of access status information is typically provided in a prior art communication system.

Digital radio systems typically have timing allocation tables for radio protocols. The tables are usually located in a MAC layer. The MAC layer is an abbreviation of Medium Access Control, which is the lower layer of the two sublayers of the Data Link Layer.

The timing allocation tables are used for transmitting and receiving signals from other devices timely from the viewpoint of the whole system. The timing information of different systems may be collected in one multiradio timing table.

Plenty of possibilities exist for obtaining access status information: the information may be read from one or more radio protocol allocation tables, it may be determined based on base band commands given to a hardware control unit, or in both ways, etc.

If a multiradio device includes a multiradio controller (implemented with a multiradio control unit, for example), the checking may be carried out by using preprocessed access status information of all the protocols or some of them.

The checking may also be carried out by using information obtained from radio protocols. A combination of the two methods is also an option.

In block 204, at least one resource unit for the use of the radio protocols is scheduled according to the access status. Resource units may be hardware elements or software elements or include both of them.

Typically, plenty of different resource units are provided, some examples of which are: receivers, transmitters, synthesizers, phase-lock loops, antennas, receiver front-end modules, power amplifiers, mixers for up- and down-conversion, analog intermediate frequency stages, analog baseband modules, analog-to-digital converters, filters, transmitter front-end modules, different digital signal processing units and voltage controlled oscillators.

The resource units may be listed according to the order of how well requirements of the radio protocols are fulfilled, for instance the resource units giving “best fit” are listed on the top of the list. Possible measures for the “best fit” are operational radio frequency band, intermediate frequency bandwidth, base band bandwidth, noise, interference, linearity, power consumption, optimized radio protocol performance with respect to link quality parameters (availability, throughput), etc. Also combinations of several criteria are an option.

In principle, suitable signal chains for radio protocols to which access is granted are selected. A signal chain may include several resource units, such as base band modules, radio frequency modules, synthesizer modules, filter modules and/or antenna modules for both signal transmission and reception.

In practice, one option is to create from the granted accesses a resource unit allocation table on the basis of which available resources can be scheduled. The scheduling takes in to account setup delays and possible reservations of quick retransmissions, etc.

Typically, determining resource availability is a part of the scheduling. If the device is not furnished with the needed resources, it is reported to the upper layers for taking further actions, such as to inform a user that the service cannot be offered. Upper layers may also be informed of the successful reservation

The resource units may be scheduled to the radio protocols according to radio protocol priorities. This may be used to guarantee resources to high priority protocols in case there is a lack of resources.

The “best fit” criterion may also be used in scheduling. Also a combination of protocol priorities and a resource unit “best fit” criterion is possible. Another combination criterion may be an optimized radio protocol performance with respect to link quality parameters (availability, throughput, etc.) and hardware performance (like power consumption). Other possibilities also exist.

In block 206, the at least one resource unit for the use of the radio protocols is reserved according to the access status. In block 208, the at least one reserved resource unit is configured according to the scheduling.

Configuring typically refers to the manner on which hardware (such as radio frequency parts) and software resources are arranged at a given point of time including an extension and reduction of a system and changing status and identity of allocation of selected parts, etc.

Configuration may include various tasks, such as reading from a memory the last state of a signal chain, configuring the signal chain to a previous state and storing information that the signal chain in question is reserved.

The configuring may include that a last state in the configuring is read from a memory and reserved resource units are then configured according to the read state.

Another option is that a last state of the configuring is updated based on the radio protocol access status and resource units are then configured according to the updated state.

Yet another option is that a last state of the configuring is updated based on the radio protocol access status, the updated last state is read from a memory and resource units are then configured according to the read state.

Configuration control may be carried out by using a multiradio controller or a configuration manager, for instance a radio frequency configuration manager. Timing information may be conveyed via the multiradio controller or the configuration manager.

Configuration is typically carried out by starting from upper layers and proceeding to lower layers. For instance, if radio frequency hardware resources are configured, configuring proceeds from a media access (MAC) layer to a physical layer. Then radio frequency signal paths and in the last step, radio frequency hardware signal chains are configured.

An example of a practical implementation of storing information on reservation is that when timing information indicates that a radio protocol (a radio system or service) has access to resources, the signal chain of this radio protocol is set to “active” state (in other cases, the signal chain is in “not valid” state and the radio protocol has no access to hardware of the device). When hardware is set to “active” state, the signal chain is set to an operating mode.

Some parameters of the hardware modules in the hardware chain may be adjusted during configuration. Examples of these parameters are the latest automatic gain control (AGC) setting and frequency calibration information.

There may be several signal chains for a radio protocol that uses a plurality of frequency bands, such as GSM 900/1800, due to the need of separate RF front end parts for each frequency band. There may also be separate signal chains for a receiver and a transmitter.

In cases, where available resource units cannot fulfill all protocol requests, i.e. the hardware exits but is reserved, priority routines may be added. The priority routines may be based on the Quality of Service (QoS) classification, for example.

Another possibility for finding resources for a particular radio protocol is that protocols already configured are directed to use other resources. It is also possible to use time-sharing or a lower QoS class. A served radio protocol may also be dropped out, if necessary.

After configuration, information on reserved resources is stored. The storage may be a memory table. Usually, the information is also reported to upper layers. Reporting is important especially in cases, where discontinuation of service happens due to the lack of resources.

An embodiment of the control method described above may offer a remarkably fast signal path reservation in a multiradio device, if resource units of signal chains for different radio protocols have been defined in advance and the information on the whole signal chain has been stored in a memory, such as in a table. Then scheduling may be controlled based on the stored information. There is not necessarily need to schedule the signal chain on a module by module basis. Instead, scheduling may be carried out on a signal chain basis.

A procedure for determining a signal chain for a radio protocol may consist of first checking that a device can provide a needed resource units and then storing the signal chain in a memory as a list of required resource units or as a pre-configured chain.

The embodiment ends in block 210. The arrow 212 depicts one possibility to repeat the embodiment. In this case, the repetition is carried out for another radio protocol.

A new receiver or transmitter signal chain for a radio protocol is usually defined in such a manner that required resource units are selected from a list of available resources. The signal chains may be defined for all radio protocols which can be realized by the available resource units. The defined signal chains may be stored in a memory to be used in scheduling.

Information on the configuration of a multiradio device may be reported to upper layers. Information to be reported may be the number of parallel signal paths, supported radio protocols, radio protocols to be supported simultaneously, etc.

In the following, an example of controlling the configuration of a multiradio device is explained to clarify an embodiment of the invention.

Timing of each radio protocol to which access has been requested, is stored in a memory table called a timing allocation table. This table may the same as used in prior art devices or a different one.

Scheduling of a signal chain is controlled by the timing allocation table. Typically, hardware resources required for each radio protocol are stored in another table called a system allocation table. The information stored in the system allocation table is used in scheduling.

A last state of the signal chain is read from a memory storage called a signal chain state memory.

The signal chain is configured to a previous state including parameter adjusting. Parameters may be a frequency band, the amount of power amplifying, etc.

Then, the signal chain is marked activated in the system allocation table for updating information on reserved resources.

Then, after the reserved resources for the particular radio protocol are not needed anymore, that is if there is no longer a need for data transfer, the last state of the signal chain is stored in the signal state memory, hardware resources are released and the system allocation table is updated.

It should be noted that it is also possible to schedule, reserve and configure a plurality of signal chains for one radio protocol and store the alternate signal chains as a list of required resource units. The radio protocol may also have a primary and alternate signal chains. Further, the radio protocol may reserve one signal chain for use for a scheduled period and other alternative signal chains for a following scheduled period, in which case resource units of unreserved signal chains are released for the use of other radio protocols.

Embodiments of the invention or parts of them may be implemented as a computer program comprising instructions for executing a computer process for configuration controlling, for example, checking access status of a plurality of radio protocols, scheduling at least one resource unit for the use of the radio protocols according to the access status, reserving the at least one resource unit for the use of the radio protocols according to the access status and configuring the at least one reserved resource unit according to the scheduling.

The computer program may be stored on a computer program distribution medium readable by a computer or a processor. The computer program medium may be, for example but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Other than a computer program implementation solutions are also possible, such as different hardware implementations (modules), e.g. a circuit built of separate logics components or one or more client-specific integrated circuits (Application-Specific Integrated Circuit, ASIC). A hybrid of these implementations is also feasible.

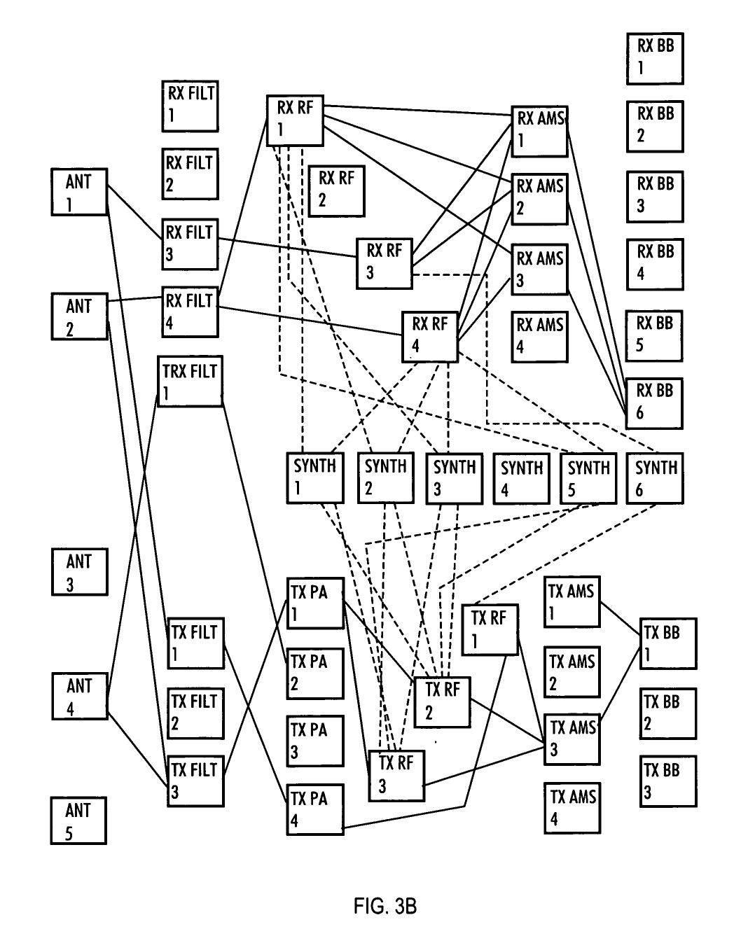

FIGS. 3A-3C show an example of a typical multiradio hardware platform that can be implemented by using one or more Application Specific Integrated Circuits (ASIC). In the figures, connections are marked suggestively, not in a manner they would be implemented in practice. In the platform of the figures, 5 antenna modules are provided (ANT 1, ANT 2, ANT 3, ANT 4, ANT 5). There are also 4 receiver filter modules (RX FILT 1, RX FILT 2, RX FILT 3, RX FILT 4), one transceiver filter module (=duplex filter) (TRX FILT 1), 4 receiver radio frequency modules (RX RF 1, RX RF 2, RX RF 3, RX RF 4), 4 receiver analog and mixed signal (intermediate frequency blocks or analog baseband blocks and analog-to-digital converters) modules (RX AMS 1, RX AMS 2, RX AMS 3, RX AMS 4), 6 receiver base band modules (RX BB 1, RX BB 2, RX BB 3, RX BB 4, RX BB 5, RX BB 6), 6 synthesizer modules (SYNTH 1, SYNTH 2, SYNTH 3, SYNTH 4, SYNTH 5, SYNTH 6), 3 transmitter filter modules (TX FILT 1, TX FILT 2, TX FILT 3), 4 transmitter power amplifier modules (TX PA 1, TX PA 2, TX PA 3, TX PA 4), 3 transmitter radio frequency modules (TX RF 1, TX RF 2, TX RF 3), 4 transmitter AMS modules (TX AMS 1, TX AMS 2, TX AMS 3, RTX AMS 4) and 3 transmitter base band modules (TX BB 1, TX BB 2, TX BB 3).

FIG. 3A shows all possible signal path connections available in the exemplary implementation. For the sake of clarity, signal paths between synthesizers are marked with dotted lines.

FIG. 3B shows an example of all possible signal path configurations with two frequency bands belonging to the exemplary implementation. First frequency band is marked with a dotted line and the second is marked with a continuous line.

FIG. 3C shows an example of signal path configurations during a time slot. In FIG. 3C, signal paths for 4 different radio protocols are depicted. Different signal paths are marked with different line styles. In the following, examples of hardware allocation tables used in scheduling, reserving and/or configuring resources of the hardware platform of FIGS. 3A-C are presented. Different radio protocols are marked in the tables with [system]:

TABLE 1

| Start Time | Stop Time | System | Band | RX/TX |
|---|---|---|---|---|
| t0 | t8 | [system1] | | RX |
| t0 | t8 | [system1] | | TX |
| t0 | t2 | [system2] | bandB | TX |
| t2 | t3 | [system3] | | RX |
| t4 | t8 | [system4] | | RX |
| t6 | t7 | [system2] | bandB | RX |
| t7 | t8 | [system3] | | TX |
| t7 | t8 | [system2] | bandA | RX |
| . . . | . . . | . . . | . . . | . . . |

Table 1 shows an example of a radio protocol timing allocation table, wherein bandA refers to the first frequency band depicted in FIG. 3B, bandB means the second frequency band depicted in FIG. 3B, RX refers to a receiver and TX refers to a transmitter. Start times are selected times in increasing order.

TABLE 2

| System | Band | RX/TX | Signal Path |
|---|---|---|---|
| [system1] | | RX | ANT[2/4]/TRXFILT2,/RXRF[1/4]/ |
| | | | RXAMS[1/2/3]/RXBB1/SX[1/2/3] |
| | | TX | ANT[2/4]/TRXFILT2,/TXPA2/ |
| | | | /TXRF[2/3]/TXAMS2/TXBB3/SX[1/2/3] |
| [system2] | bandA | RX | ANT1/RXFILT3,/RXRF3/ |
| | | | RXAMS[1/2/3]/RXBB6/SX6 |
| | | TX | ANT1/TRXFILT5,/TXPA4/ |
| | | | /TXRF1/TXAMS3/TXBB1/SX6 |
| | bandB | RX | ANT[2/4]/RXFILT4,/RXRF[1/4]/ |
| | | | RXAMS[1/2/3]/RXBB6/SX[1/2/3/5] |
| | | TX | ANT[2/4]/TXFILT3,/TXPA1/ |
| | | | /TXRF[2/3]/TXAMS3/TXBB1/ |
| | | | SX[1/2/3/5] |
| [system3] | | RX | ANT[2/4]/TRXFILT2,/RXRF[1/4]/ |
| | | | RXAMS[1/2/3]/RXBB1/SX[1/2/3] |
| | | TX | ANT[2/4]/ TXPA3 |
| | | | /TXRF[2/3]/TXAMS3/TXBB2/ |
| | | | SX[1/2/3/5] |
| [system4] | | RX | ANT5/TRXFILT1,/RXRF2/ |
| | | | RXAMS4/RXBB2/SX4 |

Table 2 shows an example of a radio protocol hardware allocation table, wherein bandA refers to the first frequency band depicted FIG. 3B, bandB refers to the second frequency band depicted in FIG. 3B, RX means a receiver and TX refers to a transmitter.

Abbreviations used on the table 2 refer to FIGS. 3A-C. Synthesizers are marked in the table with abbreviation SX. The system allocation table shows signal chains for different radio protocols.

TABLE 3

| Block | Control Register Addresses |
|---|---|
| RXRF1 | [RXRF1 regs] |
| RXRF2 | [RXRF2 regs] |
| . . . | . . . |
| RXAMS3 | [RXAMS3 regs] |
| . . . | . . . |

Table 3 shows an example of a register mapping table, wherein the abbreviations refer to FIGS. 3A-C.

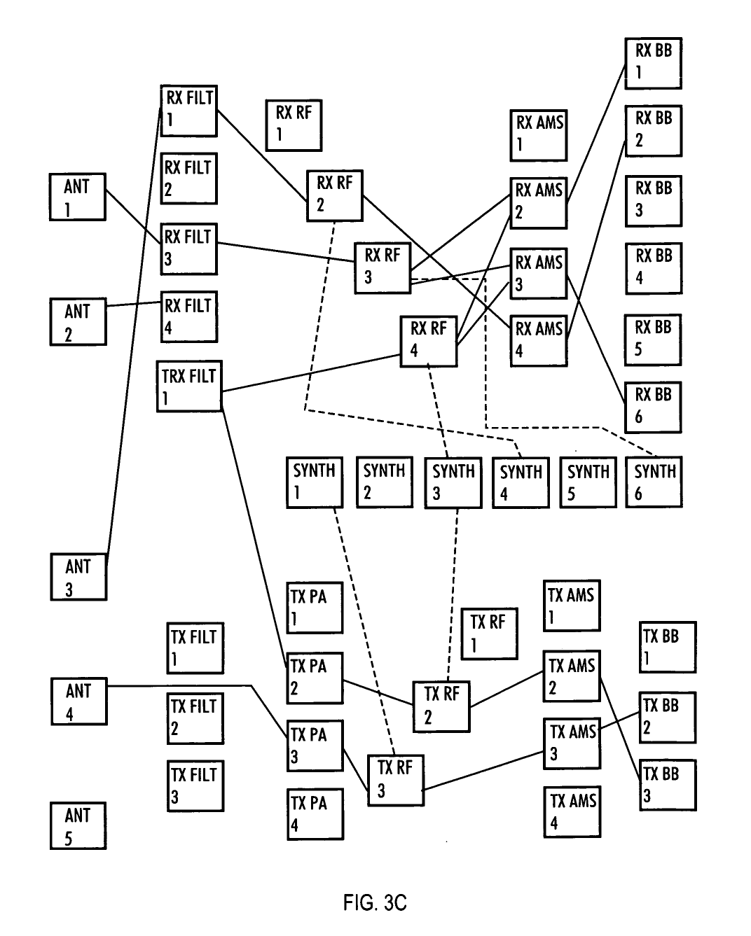

Next, a structure of a communication device providing support for a plurality of different radio protocols will be described with reference to the simplified example of FIG. 4. The embodiments are not, however, restricted to the device given as an example but a person skilled in the art may apply the solution to other devices provided with the necessary properties.

The communication device may be a mobile phone, a computer, a laptop, or a PDA (Personal Digital Assistant). It should be noticed that the communication device may also provide characteristics of several devices, such as a computer capable to offer wireless data or speech transfer services.

The communication device of the example includes a plurality of communication interfaces 412 to 416 to provide wireless radio connections 408, 410 to other devices, such as base stations. The communication interfaces typically include at least one transceiver. The communication interfaces 412 to 416 usually provide connections employing different radio access technologies. It is obvious to a person skilled in the art that the number of communication interfaces may vary from one implementation to another.

The communication device further includes a control unit 402 to control functions of the device 400. The control unit 402 comprises means for creating radio connections between the communication device 400 and other communication devices or networks. The control unit 402 also comprises means for controlling a number of simultaneous radio connections in the communication device. The control unit may be configured to perform at least partly embodiments of the control method described above. Briefly, the control unit of the example may grant different radio protocols an access to hardware, and configure the hardware properly for the active radio protocol. It may also dynamically optimize parallel hardware chains to different systems based on the grants and system prioritization.

The control unit 402 may be implemented with a digital signal processor with suitable software or with separate logic circuits, for example with ASIC (Application Specific Integrated Circuit). The control unit 402 may also be a combination of these two implementations, such as a processor with suitable software embedded within an ASIC.

The communication device typically comprises a memory unit 404 for storing defined signal chains, for instance.

The communication device 400 further comprises a user interface 406 connected to the controlling unit. The user interface 406 may comprise a keyboard, a microphone, a loudspeaker, a display, and/or a camera.

It is obvious to a person skilled in the art that the communication device may include parts, such as a battery, not depicted in FIG. 4.

Even though the invention has been described above with reference to an example according to the accompanying drawings, it is clear that the invention is not restricted thereto but it can be modified in several ways within the scope of the appended claims.

1. A control method comprising:
checking access status of a plurality of radio protocols;
scheduling at least one resource unit for a use of the radio protocols according to the access status;
reserving the at least one resource unit for the use of the radio protocols according to the access status; and
configuring the at least one reserved resource unit according to the scheduling.

2. The control method of claim 1, further comprising:
informing upper layers of the reservation of the at least one resource unit.

3. The control method of claim 1, further comprising:
informing upper layers, if sufficient number of resource units cannot be reserved for at least one radio protocol.

4. The control method of claim 1, wherein the configuring of the at least one reserved resource unit further comprises:
reading from a memory a last state in the configuring of the radio protocols and outputting a read state indicative thereof; and
configuring the at least one reserved resource unit according to the read state.

5. The control method of claim 1, further comprising:
updating a last state of the configuring of the radio protocol based on the access status of the radio protocols and outputting an updated state indicative thereof; and
configuring the at least one reserved resource unit according to the updated state.

6. The control method of claim 1, wherein the configuring of the at least one reserved resource unit further comprises:
updating a last state of the configuring of the radio protocol based on the access status of the radio protocols and outputting a read state indicative thereof;
reading from a memory the updated last state; and
configuring the at least one reserved resource unit according to the read state.

7. The control method of claim 1, further comprising:
configuring the at least one resource unit as a hardware element or a software element or to include both hardware and software elements.

8. The control method of claim 1, further comprising:
adjusting parameters of reserved resource units during configuration.

9. The control method of claim 1, further comprising:
storing information on reserved resources.

10. The control method of claim 1, further comprising:
defining signal chains for different radio protocols by checking that a device can provide needed resource units and storing the signal chains in a memory as a list of required resource units.

11. The control method of claim 1, further comprising:
reading the access status from at least one radio protocol allocation table.

12. The control method of claim 1, further comprising:
determining the access status of a radio protocol based on base band commands given to a hardware control unit.

13. The control method of claim 1, further comprising:
determining the access status of a radio protocol by reading from at least one radio protocol allocation table and on the basis of base band commands given to a hardware control unit.

14. The control method of claim 1, further comprising:
scheduling, reserving and configuring of a plurality of signal chains for a radio protocol and storing the alternate signal chains as a list of required resource units.

15. The control method of claim 1, further comprising:
scheduling, reserving and configuring of a plurality of signal chains for a radio protocol and storing the alternate signal chains as a list of required resource units, wherein a radio protocol has a primary and at least one alternate signal chain.

16. The control method of claim 1, further comprising:
reserving one signal chain for use for a scheduled period using a radio protocol; and
reserving at least one alternative signal chain for a following scheduled period using the radio protocol.

17. The method of claim 1, further comprising:
reserving one signal chain for use for a scheduled period using a radio protocol;
reserving at least one alternative signal chain for a following scheduled period using the radio protocol; and
releasing resource units of unreserved signal chains for the use of other radio protocols.

18. The control method of claim 1, further comprising:
carrying out the checking access status of a plurality of radio protocols by using preprocessed access status information of predetermined protocols, the information being provided by a multiradio controller.

19. The control method of claim 1, further comprising:
carrying out the checking access status of a plurality of radio protocols by using information obtainable from the radio protocols and by using preprocessed access status information of predetermined protocols, the information being provided by a multiradio controller.

20. The control method of claim 1, further comprising:
scheduling the at least one resource unit to the radio protocols according to radio protocol priorities.

21. The control method of claim 1, further comprising:
listing the resource units according to an order in which requirements of the radio protocols are fulfilled.

22. An apparatus, comprising:
means for checking access status of a plurality of radio protocols;
means for scheduling at least one resource unit for a use of the radio protocols according to the access status;
means for reserving the at least one resource unit for the use of the radio protocols according to the access status; and
means for configuring the at least one reserved resource unit according to the scheduling.

23. An apparatus configured to:
check access status of a plurality of radio protocols;
schedule at least one resource unit for the use of the radio protocols according to the access status;
reserve the at least one resource unit for a use of the radio protocols according to the access status; and
configure the at least one reserved resource unit according to the scheduling.

24. The apparatus of claim 23, further configured to inform upper layers of the reservation of the at least one resource unit.

25. The apparatus of claim 23, further configured to inform upper layers, if sufficient number of resource units cannot be reserved for at least one radio protocol.

26. The apparatus of claim 23, wherein the at least one reserved resource unit is configured to read from a memory a last state in the configuring of the radio protocol and output a read state indicative thereof; and
configure the at least one reserved resource unit according to the read state.

27. The apparatus of claim 23, further configured to:
update a last state of the configuring of the radio protocol based on the access status of the radio protocols and output an updated state indicative thereof; and
configure the at least one reserved resource unit according to the updated state.

28. The apparatus of claim 23, wherein the at least one reserved resource unit is configured to
update a last state of the configuring of the radio protocol based on the access status of the radio protocols;
read from a memory the updated last state; and
configure the at least one reserved resource unit according to the read state.

29. The apparatus of claim 23, wherein the at least one resource unit is a hardware element or a software element or the at least one resource unit includes both hardware and software elements.

30. The apparatus of claim 23, further configured to adjust parameters of reserved resource units during configuration.

31. The apparatus of claim 23, further configured to store information on reserved resources.

32. The apparatus of claim 23, further configured to define signal chains for different radio protocols by checking that a device can provide needed resource units and storing the signal chains in a memory as a list of required resource units.

33. The apparatus of claim 23, further configured to read the access status from at least one radio protocol allocation table.

34. The apparatus of claim 23, further configured to determine the access status of a radio protocol based on base band commands given to a hardware control unit.

35. The apparatus of claim 23, further configured to determine the access status of a radio protocol by reading from at least one radio protocol allocation table and on the basis of base band commands given to a hardware control unit.

36. The apparatus of claim 23, further configured to carry out the checking of access status of a plurality of radio protocols by using preprocessed access status information of predetermined protocols, the information being provided by a multiradio controller.

37. The apparatus of claim 23, further configured to carry out the checking of access status of a plurality of radio protocols by using information obtainable from the radio protocols and by using preprocessed access status information of predetermined protocols, the information being provided by a multiradio controller.

38. The apparatus of claim 23, wherein the at least one resource unit is scheduled to the radio protocols according to radio protocol priorities.

39. The apparatus of claim 23, wherein the resource units are listed according to an order in which requirements of the radio protocols are fulfilled.

40. The apparatus of claim 23, wherein the apparatus is a communication device.

41. A computer program product encoding a computer program of instructions for executing a computer process for configuration controlling, the process comprising:
checking access status of a plurality of radio protocols;
scheduling at least one resource unit for a use of the radio protocols according to the access status;
reserving the at least one resource unit for the use of the radio protocols according to the access status; and
configuring the at least one reserved resource unit according to the scheduling.

42. A computer program distribution medium readable by a computer and encoding a computer program of instructions for executing a computer process for configuration controlling, the process comprising:
checking access status of a plurality of radio protocols;
scheduling at least one resource unit for the use of the radio protocols according to the access status;
reserving the at least one resource unit for a use of the radio protocols according to the access status; and
configuring the at least one reserved resource unit according to the scheduling.

43. The computer program distribution medium of claim 42, the distribution medium including at least one of the following media: a computer readable medium, a program storage medium, a record medium, a computer readable memory, a computer readable software distribution package, a computer readable signal, a computer readable telecommunications signal, and a computer readable compressed software package.

44. An apparatus, comprising:
a checking unit configured to check access status of a plurality of radio protocols;
a scheduling unit configured to schedule at least one resource unit for a use of the radio protocols according to the access status;
a reserving unit configured to reserve the at least one resource unit for the use of the radio protocols according to the access status; and
a configuring unit to configure the at least one reserved resource unit according to the scheduling.
